(19) United States
(12) Patent Application Publication
(10) Pub. No.: US 2014/0116141 A1
(43) Pub. Date: May 1, 2014

(54) METHOD FOR DETECTING DEFECTS IN TREATING IRON COMPONENTS

(71) Applicant: George W. RHODES, Corrales, NM (US)

(72) Inventor: George W. RHODES, Corrales, NM (US)

(21) Appl. No.: 14/062,178

(22) Filed: Oct. 24, 2013

Related U.S. Application Data
(60) Provisional application No. 61/795,783, filed on Oct. 25, 2012.

(51) Int. Cl. G01N 29/14

(52) U.S. Cl. CPC G01N 29/14
USPC 73/587

(57) ABSTRACT

A method of testing a treating iron component for the presence of a defect in structural integrity is presented. The treating iron component is subjected to test conditions of hydrostatic pressure. Test acoustic emission from the treating iron component while under the test conditions can be detected by at least one acoustic sensor and compared to standard acoustic emission detected by subjecting a similar non-defective treating iron component to the same test conditions of hydrostatic pressure. An increase in the test acoustic emission compared to the standard acoustic emission indicates the presence of a defect in the structural integrity of the treating iron component.

### CROSS REFERENCE TO RELATED APPLICATIONS

This application claims the benefit of U.S. Provisional Application Ser. No. 61/795,783, filed Oct. 25, 2012, which is incorporated herein by reference.

### BACKGROUND

This invention relates to the testing of high-pressure equipment used in oil field applications. More specifically, this invention relates to the nondestructive testing of high pressure treating iron parts to certify their suitability for safely maintaining high pressure in continued service.

High pressure fluids pumped in oil field applications, and various other applications, often cause stress to pipes and other metal tubulars, unions, vessels and other components beyond their rated capacity. This is particularly true for hydraulic fracturing operations. The subsequent failure of these components may lead to injury to personnel and/or equipment failure.

The risk of failure of a component may be increased by certain equipment designs and operating regimes. For example, corrosion of steel or iron piping may be influenced by water and/or oxygen. If the material being transported is corrosive, then the walls of the component may be gradually corroded over time. Further, in hydraulic fracturing operations, the presence of proppants in the pressurized fluid may increase the erosion of the walls of the component. Cracking can also be initiated in components by cyclic loading at stress concentration points and reverse bending fatigue.

The standard method to certify that a component can withstand operational pressures is to perform dye penetrant (Fluorescent Penetrant Inspection, FPI) and/or magnetic particle penetrant (Magnetic Particle Inspection, MPI) tests to reveal defects (cracks and corrosion). These methods are subject to interpretation by the human eye and therefore require judgment to determine whether the test piece passed or failed the test. Consequently, these methods have been proven to be unreliable. If the test piece were falsely failed, there may be unnecessary cost in replacing a non-defective component. More importantly, if the test piece were falsely passed, the use of the component in high-pressure operations may place personnel and equipment at risk. Further, the subsequent failure of the component may result in prolonged downtime.

Therefore, there is need for an improved method of detecting cracks and/or corrosion in a component for use in high pressure applications.

Acoustic Emission (AE) monitoring relies on the principle that stress forces acting on a material or component will deform the bulk body. Such dimensional changes cause the expansion of insipient cracks, resulting in sound emission. In the case of corrosion flaking off from contact areas, the emissions are continuous, while burst signals are emitted in the case of crack propagation.

ASTM E-569 entitled: “Standard Practice for Acoustic Emission Monitoring of Structures During Controlled Stimulation”, and ASTM E-1139 entitled: “Standard Practice for Continuous Monitoring of Acoustic Emission from Metal Pressure Boundaries” do not provide specifics regarding an actual method to stimulate the stress and create a pass/fail test. In addition, while ultrasonic methods to detect cracks under hydrostatic pressure are known, none employ acoustic emission resulting from the induced stresses associated with this method of stimulation.

### SUMMARY

It is therefore desirable to employ a technique for monitoring the structural integrity of a component whereby a sensor-based system can provide a signal to either pass or fail the test piece. The present method involving measurement of acoustic emissions (AE) has been shown to produce signals from which acceptance or rejection of a test piece can be made without relying on the visual interpretation required in FPI and MPI. Therefore, the AE method can minimize the likelihood of human error in the pass/fail loop.

Without being bound by theory, when a mechanical stimulus, such as hydrostatic pressure, is applied to a component, stress will be induced in the component, resulting in physical movement within the structure. If a defect, including but not limited to a crack or corrosion, is present in the test piece, this movement will cause emission of acoustic noise. In contrast, a similar test piece which is not cracked, corroded or otherwise defective or damaged will emit significantly less acoustic noise under the same stimulus or pressure.

Thus, one aspect of the invention is directed to a method of testing a treating iron component for the presence of a defect in structural integrity. The treating iron component is subjected to test conditions of hydrostatic pressure. Test acoustic emission from the treating iron component while under the test conditions can be detected by at least one acoustic sensor and compared to standard acoustic emission detected by subjecting a similar non-defective treating iron component to the same test conditions of hydrostatic pressure. An increase in the test acoustic emission compared to the standard acoustic emission indicates the presence of a defect in the structural integrity of the treating iron component.

### BRIEF DESCRIPTION OF THE DRAWINGS

The purpose and advantages of the present invention will be apparent from the following detailed description in conjunction with the appended drawings in which:

FIG. 1 is a block diagram representing a system useful to carry out one embodiment of the present method;

FIG. 2A represents a layout of a test assembly including a test piece;

FIG. 2B represents another layout of a test assembly including another test piece;

FIG. 3 is a photograph of a test assembly for a system according to FIG. 1, wherein the test assembly is laid out according to the layout of FIG. 2A;

FIG. 4 is a block diagram representing a system useful to carry out another embodiment of the present method;

FIG. 5 is a photograph of a test assembly for a system according to FIG. 4;

FIG. 6 is a plot of a hydrostatic pressure profile obtained using the present method;

FIG. 7A is a plot of acoustic events for a non-defective test piece recorded using the present method;

FIG. 7B is a plot of acoustic events for a defective test piece recorded using the present method;

FIG. 8A is a three-dimensional plot of triangulated acoustic events for a non-defective test piece recorded using the present method; and

FIG. 8B is a three-dimensional plot of triangulated acoustic events for a defective test piece recorded using the present method.

### DETAILED DESCRIPTION

The term “test piece” as used herein refers to components used in high pressure operations whose structural integrity can be tested in the present method. In at least one embodiment, the components can be treating iron components used in surface piping for delivering well treatment fluids to a wellbore. Test pieces include but are not limited to pipes, metal tubulars, unions, swivels, T's, Y's, laterals, manifolds, adaptors and valves.

The term “non-defective” as used herein refers to a new or previously unused component. Such new components can be further verified as being free from cracks or other defects by testing by the present method or by an alternative method such as FPI or MPI.

The term “acoustic emission” as used herein refers to an emission of acoustic energy from a test piece when subjected to hydrostatic pressure as described herein. Acoustic emission includes but is not limited to individual acoustic events, and is detectable by an acoustic sensor.

The term “amplitude” as used herein refers to the maximum amplitude of a sound wave associated with an acoustic event, and can be measured in decibels.

The term “count” as used herein refers to the number of pulses having an amplitude above a predefined threshold for a sound wave associated with an acoustic event.

The present method is directed to testing a treating iron component for the presence of a defect in structural integrity by subjecting the treating iron component, or test piece, to test conditions of hydrostatic pressure and measuring acoustic events emitted by the test piece in response to the hydrostatic pressure stimulus. In at least one embodiment, the test piece can be attached to other components, including but not limited to adapters and/or other components of varying shape or configuration, such as straight components, T-components and swivel components, to form a test assembly. In at least one embodiment, a test assembly includes more than one test piece. The use of such a test assembly allows two or more test pieces to be tested simultaneously using the present method.

The test piece or test assembly can be filled with a hydraulic fluid, capped or sealed to contain the hydraulic fluid, and attached to a hydraulic pump or another means for increasing the hydrostatic pressure of the hydraulic fluid, such as are known in the art. The air in the test piece or assembly can be purged as the test piece or test assembly is filled with the hydraulic fluid. In at least one embodiment, the hydraulic fluid is water; however, it would be understood by a person skilled in the art that any suitable fluid can be used. In at least one embodiment, the hydraulic pump includes a pressure sensor for monitoring the pressure of the fluid in the test piece. In at least one alternative embodiment, a pressure sensor can be attached directly or indirectly to the test piece or test assembly, as long as it serves to measure the hydrostatic pressure inside the test piece.

In at least one alternative embodiment, the test piece or test assembly, which has been filled with hydraulic fluid, capped or sealed, and attached to a hydraulic pump or another means for increasing the pressure of the fluid, can be submersed in a coupling fluid in an immersion tank. As will be understood by the skilled person, the immersion tank can have any suitable shape, including but not limited to a rectangular solid, and is desirably large enough that the test piece or test assembly is completely submersed in the coupling fluid. In at least one embodiment, the coupling fluid is water, however it would be understood by a person skilled in the art that any fluid having acoustic properties suitable for transmitting sound emitted during acoustic events can be used. In at least one embodiment, the coupling fluid comprises the same fluid as the hydraulic fluid.

In at least one embodiment, the test piece is subjected to one or more predetermined hydrostatic pressure levels, each of which is maintained for a predetermined time interval so as to allow any resulting acoustic events to be detected and recorded. The skilled person can readily select suitable predetermined time intervals which will allow for the test piece to emit any acoustic events and stabilize at each hydrostatic pressure level before advancing to the next hydrostatic pressure level. In at least one embodiment the highest hydrostatic pressure level can be up to 10% higher than the recommended rating of the test piece, as described in standard ASTM E-569 (Standard Practice for Acoustic Emission Monitoring of Structures During Controlled Stimulation). In at least one embodiment the highest hydrostatic pressure level can be up to 50% higher than the recommended rating of the test piece. The person of skill in the art can readily select other suitable intermediate and maximum hydrostatic pressure levels.

Acoustic events are detected using one or more acoustic sensors. In at least one embodiment, one or more of the acoustic sensor(s) can be attached directly to the test piece. In at least one embodiment, one or more of the acoustic sensor(s) can be attached to components of the test assembly other than the test piece. In at least one embodiment, when the test piece or test assembly is submersed in a coupling fluid in an immersion tank, one or more acoustic sensors can be attached to the immersion tank at one or more locations, such that the distance of each sensor from the test piece can be determined. In at least one embodiment, the acoustic sensor(s) can be attached to one or more walls of the immersion tank.

In at least one embodiment, each acoustic sensor is a microphone. In at least one embodiment, the acoustic sensor(s) record acoustic emissions in the range of 150 kHz to 450 kHz. In at least one embodiment, parameters related to the acoustic events detected by the acoustic sensor(s), including but not limited to number of events, amplitude and count, are measured and recorded. In at least one embodiment, the threshold amplitude above which an acoustic event will be detected by an acoustic sensor is from about 40 dB to about 60 dB. In at least one embodiment, the threshold amplitude is about 40 dB. In at least one embodiment, the threshold amplitude is about 45 dB. In at least one embodiment, the threshold amplitude is about 50 dB. In at least one embodiment, the threshold amplitude is about 55 dB. In at least one embodiment, the threshold amplitude is about 60 dB. The skilled person will be readily able to select a suitable threshold amplitude which is appropriate for the type of test piece or component being tested.

In at least one embodiment, the acoustic sensor can be connected to an amplifier. In at least one embodiment, the acoustic sensor(s) can be connected to a digital signal processor, either directly or through an amplifier. The digital signal processor can transform the acoustic signal detected by the acoustic sensor(s) into a digital form for subsequent transfer to a computer, where the data associated with the acoustic events can be recorded, manipulated, stored, and/or displayed. Such data include but are not limited to the number of acoustic events, their amplitude and count values and the time and pressure at which the acoustic events were emitted.

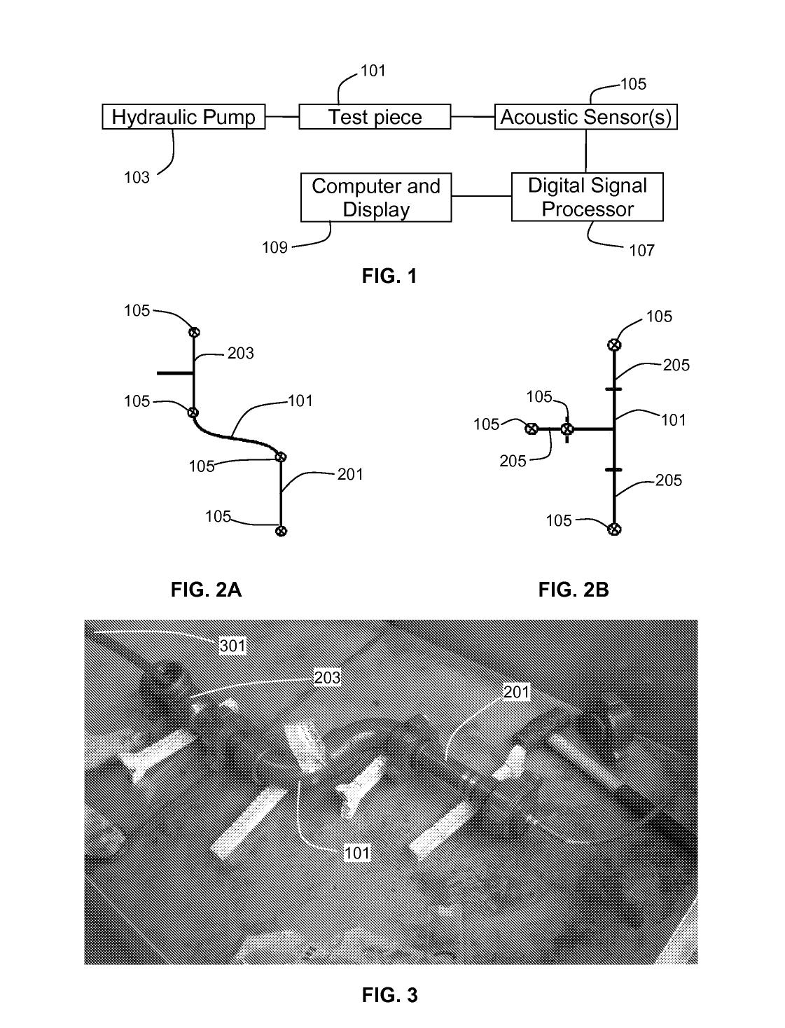

FIG. 1 shows, in diagrammatic form, a system which can be used to carry out the present method. Test piece 101 is attached to a hydraulic pump 103 and one or more acoustic sensors 105 directly, or as part of a test assembly containing one or more additional components. Suitable additional components include but are not limited to straight component 201 or T-component 203, as indicated in FIGS. 2A and 3, or adaptors 205, as indicated in FIG. 2B. Hydraulic pump 103 can be attached to test piece 101 by means of a hydraulic hose 301, seen in FIG. 3. A pressure sensor can monitor the hydrostatic pressure inside the test piece or test assembly.

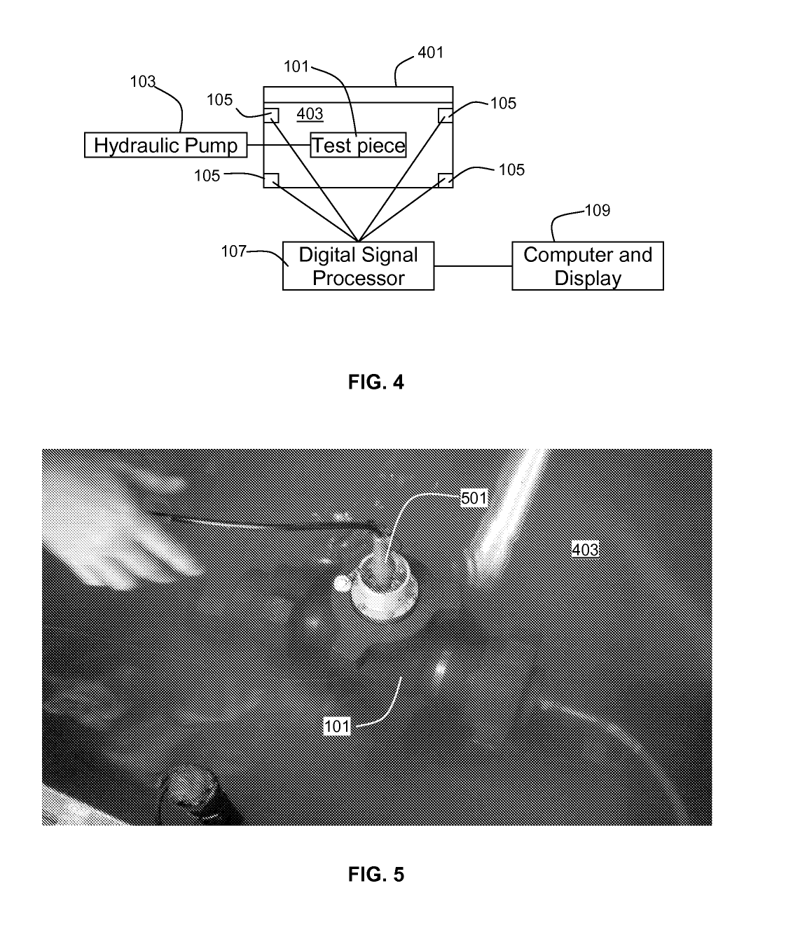

With reference to FIGS. 4 and 5, an alternative embodiment of the present method can be carried out by another test system. Test piece 101 is attached to a hydraulic pump 103 directly, or as part of a test assembly, and the test piece or test assembly is submersed in coupling fluid 403 in an immersion tank 401. A pressure sensor 501 can monitor the hydrostatic pressure inside the test piece or test assembly, as seen in FIG. 5. One or more acoustic sensors 105 are attached to immersion tank 401.

The acoustic sensor(s) 105 detect acoustic events emitted from the test piece as the hydrostatic pressure is increased inside the test piece or test assembly, either directly from the attached test piece or test assembly, or as transmitted through a coupling fluid. The signals generated by detection of the acoustic events are sent to a digital signal processor 107, directly or through an intermediate amplifier (not shown). The digital signal processor 107 processes the signals for transfer to a computer and display 109.

In use, a test system is assembled containing a new, non-defective component, filled with a hydraulic fluid and attached to a hydraulic pump and one or more pressure sensors as described above. The hydrostatic pressure is increased in the component under controlled test conditions. In at least one embodiment, the component is subjected to one or more predetermined hydrostatic pressure levels, each of which is maintained for a predetermined time interval. The acoustic events emitted are detected by one or more acoustic sensors, and parameters related to the acoustic events are measured and recorded, to determine a standard non-defective acoustic profile for the non-defective component and for non-defective components having substantially identical characteristics, including but not limited to shape, size, material and configuration.

In at least one embodiment, determining a standard non-defective acoustic profile can include determining a plurality of standard non-defective acoustic profiles by testing a plurality of new, non-defective components having substantially identical characteristics under substantially identical test conditions as described above. An average or composite standard non-defective acoustic profile and/or an expected normal variation for the standard non-defective acoustic profile can be determined from the plurality of standard non-defective acoustic profiles. The person of skill in the art will be aware of methods by which the average or composite standard non-defective acoustic profile and/or the expected normal variation can be determined, including but not limited to well-known statistical methods. In at least one embodiment, determination of the average or composite standard non-defective acoustic profile and/or the expected normal variation can be carried out by a computer.

In at least one embodiment, determination of the standard non-defective acoustic profile can be carried out by a computer. In at least one embodiment, one or more standard non-defective acoustic profiles for one or more different components or types of components can be stored on a computer-readable medium for use in comparison at a later time. Furthermore, indication of the test conditions under which each standard non-defective acoustic profile was generated can also be stored on a computer-readable medium so that the same test conditions can be replicated at a later time.

The test system is then reassembled with a test piece having characteristics which are substantially identical to those of the previously tested non-defective component, such that the non-defective component and the test piece are directly comparable. The test piece is filled with the hydraulic fluid and subjected to the test conditions of hydrostatic pressure. The acoustic events emitted are measured and recorded, to determine a test acoustic profile for the test piece. In at least one embodiment, determination of the test acoustic profile can be carried out by a computer.

The test acoustic profile is then compared to the standard non-defective acoustic profile. If the acoustic emission in the test acoustic profile is less than and/or within a predetermined margin of the acoustic emission in the standard non-defective acoustic profile, the test piece is determined to be non-defective. However, if the acoustic emission in the test acoustic profile is greater than the acoustic emission in the standard non-defective acoustic profile and outside of the predetermined margin, the test piece is determined to be defective. In at least one embodiment, comparison of the acoustic emission of the test acoustic profile to the acoustic emission in the standard non-defective acoustic profile is carried out by a computer.

The person of skill in the art will understand how to determine a suitable predetermined margin. For example, the predetermined margin can be determined by analysis of the expected normal variation for the standard non-defective acoustic profile obtained by testing a plurality of non-defective components having substantially identical characteristics under substantially identical test conditions as described above. In at least one embodiment, determination of the predetermined margin can be carried out by a computer.

In at least one embodiment, comparison of the acoustic emission of the test acoustic profile to the acoustic emission in the standard non-defective acoustic profile includes but is not limited to comparison of at least one of the number, amplitude and count of the acoustic events emitted during the acoustic emission. In at least one embodiment, the comparison is carried out by a computer. Thus, in at least one embodiment, if the number, amplitude and count of the acoustic events emitted by the test piece are less than, or within a predetermined margin of, the corresponding number, amplitude and count of the acoustic events emitted by the comparable non-defective component under the same test conditions, the test piece is determined to be non-defective. Furthermore, in at least one embodiment, if one or more of the number, amplitude and count of the acoustic events emitted by the test piece is greater than, and outside of a predetermined margin of, the corresponding number, amplitude or count of the acoustic events emitted by the comparable non-defective component under the same test conditions, the test piece is determined to be defective.

In at least one embodiment, determination of whether the acoustic emission of the test acoustic profile is within or outside of the predetermined margin of the acoustic emission in the standard non-defective acoustic profile includes but is not limited to a statistical analysis of the difference between the acoustic emission of the test acoustic profile and the acoustic emission in the standard non-defective acoustic profile. Suitable methods of statistical analysis are known in the art, and, in at least one embodiment, can be carried out by a computer.

In at least one embodiment of the present method when the test piece or test assembly is submersed in a coupling fluid in an immersion tank, a plurality of acoustic sensors can each be attached to a different location in the immersion tank to define a three-dimensional sensor arrangement, such that the distance of each sensor from the test piece or test assembly can be determined. When an acoustic event is emitted, the time of arrival of the acoustic signal at each acoustic sensor can be recorded. By comparing the times of arrival of the acoustic signal at each sensor as it passes through the coupling fluid, the distance of each sensor from the acoustic event can be determined and the location of origin of the acoustic event can be calculated by triangulation, for example, as will be understood by the skilled person. In this way, the location of the defect or defects in the test piece or test assembly can be identified. Thus, if more than one defective test piece is present in the test assembly, the location of each defective test piece can be identified. In at least one embodiment, calculation of the location of origin of each acoustic event is carried out by a computer. In at least one embodiment, identification of the location of the defect or defects in the test piece is carried out by a computer.

### EXAMPLES

Other features of the present invention will become apparent from the following non-limiting examples which illustrate, by way of example, the principles of the invention.

### Example 1

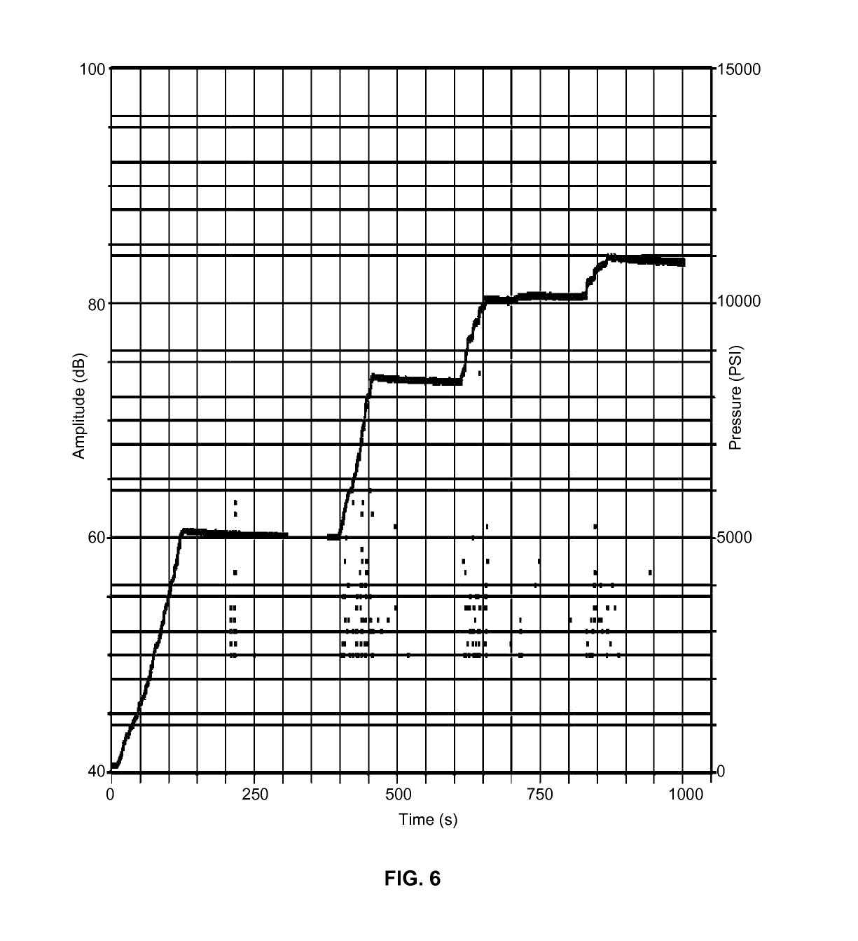

A T-component rated for 10,000 psi and known to be defective is filled with water, sealed, attached to a hydraulic pump and a pressure sensor and submersed in water inside an immersion tank to which acoustic sensors are attached. The hydrostatic pressure within the test piece is increased sequentially to 5000 psi, 8500 psi, 10,000 psi and 11,000 psi, and is held at each pressure level for about 120 to about 300 seconds. Acoustic events are detected by the acoustic sensors and the time and amplitude of each acoustic event are recorded. A plot of the hydrostatic pressure (line) and the amplitude of detected acoustic events (each represented by an individual point) over time is shown in FIG. 6. A number of acoustic events at amplitudes as high as 65 dB were observed, as represented by the plotted points in FIG. 6.

### Example 2

A non-defective two-inch T-component is filled with water, sealed, attached to a hydraulic pump and a pressure sensor and submersed in water inside an immersion tank to which acoustic sensors are attached. The hydrostatic pressure inside the component is increased as described herein and acoustic events having an amplitude greater than 40 dB are detected by the sensors. The procedure is repeated with a comparable two-inch T-component known to be defective.

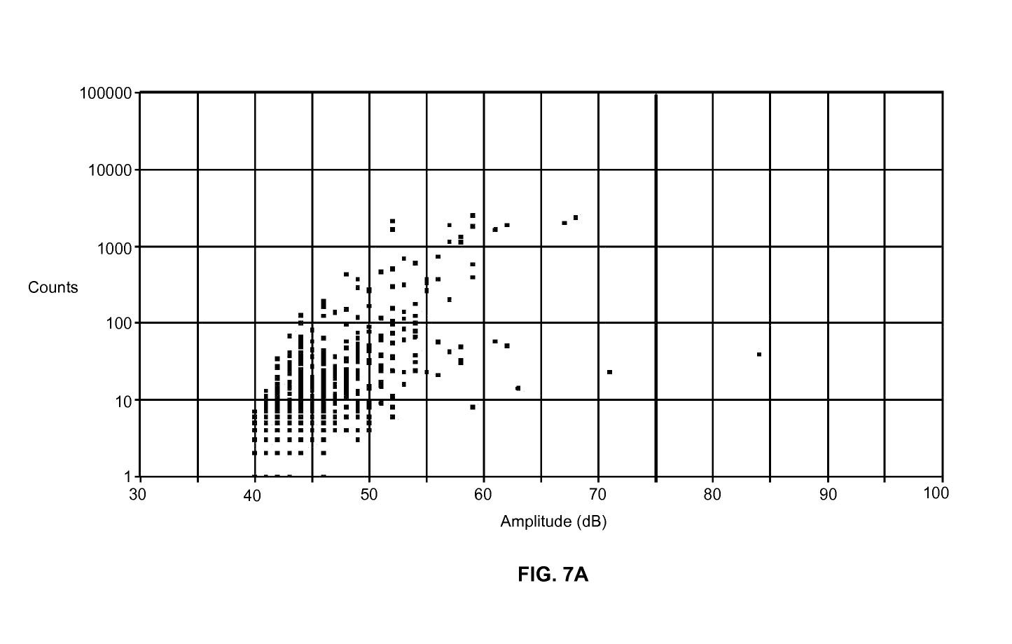

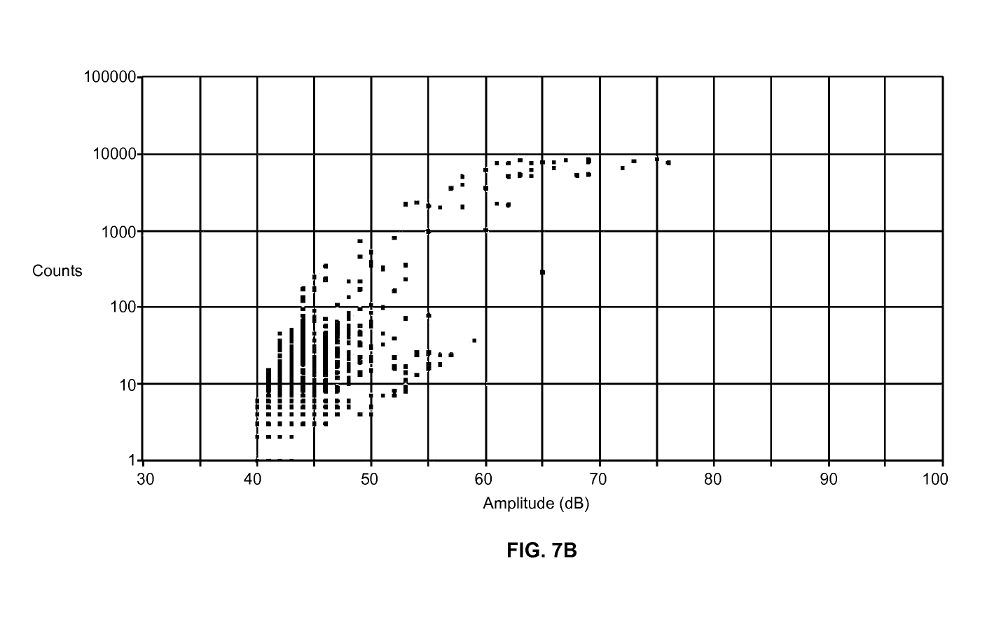

The counts and amplitude of the detected acoustic events for the non-defective and defective components are recorded and shown as a plot in FIGS. 7A and 7B, respectively. As clearly seen in FIG. 7A, only about 12 acoustic events were observed for the non-defective component having over 1000 counts, and no events were observed having over 5000 counts. Furthermore, only four acoustic events were observed to exceed 65 dB in amplitude. In contrast, for the defective component, many more acoustic events were observed with counts exceeding 5000 and with amplitudes exceeding 65 dB, as seen in FIG. 7B.

### Example 3

A non-defective two-inch T-component is filled with water, sealed, attached to a hydraulic pump and a pressure sensor and submersed in water inside an immersion tank to which acoustic sensors are attached. The hydrostatic pressure inside the component is increased as described herein and acoustic events having an amplitude greater than 40 dB are detected by the sensors. The location of origin of each acoustic event is determined from the time at which each acoustic sensor detects the event. The procedure is repeated with a comparable two-inch T-component known to be defective.

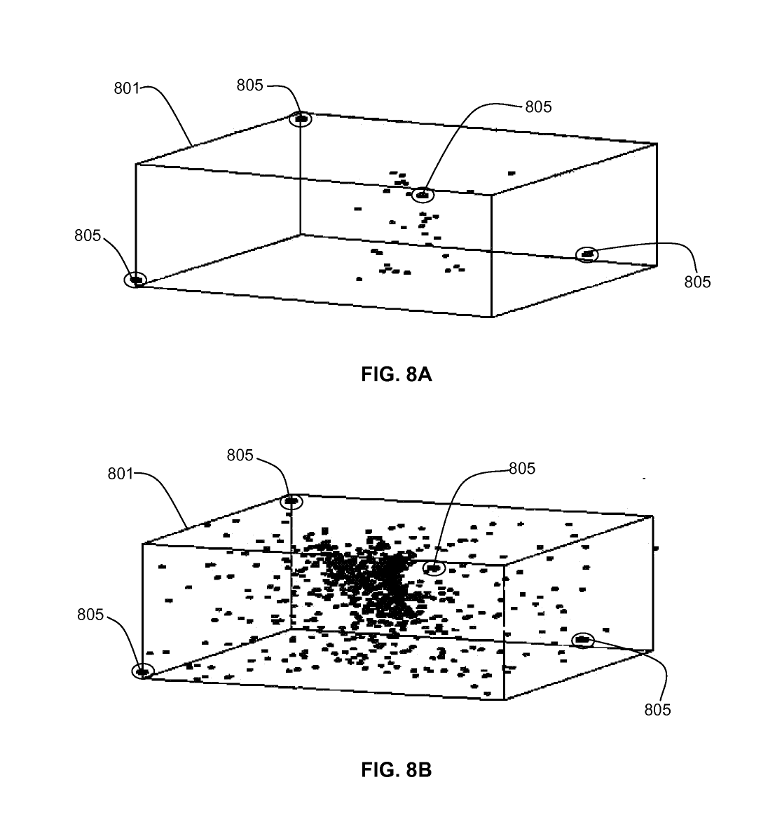

FIGS. 8A and 8B show three dimensional plots of the locations of origin (points) of the detected acoustic events for the non-defective and defective components, respectively. The outline of the immersion tank is indicated at 801 and the positions of the sensors are indicated at 805. Many more acoustic events were detected for the defective component (FIG. 8B) than for the non-defective component (FIG. 8A). Some of the points in FIG. 8B are artifacts generated by reflections of actual acoustic events. The locations of origin of the acoustic events are concentrated near the physical location of the flaw or defect in the defective component.

While the invention has been described in conjunction with the specific exemplary embodiments thereof, it is evident that many alternatives, modifications, and variations will be apparent to those skilled in the art. The embodiments described herein are intended to be illustrative of the present methods and are not intended to limit the scope of the present invention. Various modifications and changes consistent with the description as a whole and which are readily apparent to the person of skill in the art are intended to be included. The appended claims should not be limited by the specific embodiments set forth, but should be given the broadest interpretation consistent with the description as a whole.

1. A method of testing a treating iron component for the presence of a defect in structural integrity, the method comprising:
subjecting the treating iron component to test conditions of hydrostatic pressure;
detecting test acoustic emission from the treating iron component under said test conditions, wherein the test acoustic emission is detected by at least one acoustic sensor; and
comparing the test acoustic emission to standard acoustic emission detected by subjecting a substantially identical non-defective treating iron component to the test conditions of hydrostatic pressure;
wherein an increase in the test acoustic emission compared to the standard acoustic emission indicates the presence of a defect in the structural integrity of the treating iron component.

2. The method of claim 1, wherein the at least one acoustic sensor is attached to the treating iron component.

3. The method according to claim 2 wherein subjecting the treating iron component to test conditions of hydrostatic pressure comprises:
subjecting the treating iron component to at least one predetermined hydrostatic pressure level; and
maintaining each said hydrostatic pressure level for a predetermined time interval.

4. The method according to claim 2 wherein detecting the test acoustic emission comprises detecting one or more test acoustic events and measuring one or more parameters of the test acoustic events.

5. The method according to claim 4 wherein the parameters are selected from number of acoustic events, count and amplitude.

6. The method of claim 1, further comprising assembling a test assembly comprising at least one treating iron component prior to subjecting the at least one treating iron component to the test conditions of hydrostatic pressure, wherein the at least one acoustic sensor is attached to the test assembly.

7. The method according to claim 6 wherein subjecting the at least one treating iron component to test conditions of hydrostatic pressure comprises:
subjecting the at least one treating iron component to at least one predetermined hydrostatic pressure level; and
maintaining each said hydrostatic pressure level for a predetermined time interval.

8. The method according to claim 6 wherein detecting the test acoustic emission comprises detecting one or more test acoustic events and measuring one or more parameters of the test acoustic events.

9. The method according to claim 8 wherein the parameters are selected from number of acoustic events, count and amplitude.

10. The method of claim 1, further comprising submersing the treating iron component in a coupling fluid in an immersion tank prior to subjecting the treating iron component to the test conditions of hydrostatic pressure; and
wherein the at least one acoustic sensor is attached to the immersion tank.

11. The method of claim 1, further comprising:
assembling a test assembly, wherein the test assembly comprises at least one treating iron component; and
submersing the test assembly in a coupling fluid in an immersion tank prior to subjecting the at least one treating iron component to the test conditions of hydrostatic pressure;
wherein the at least one acoustic sensor is attached to the immersion tank.

12. The method according to claim 11 wherein subjecting the at least one treating iron component to test conditions of hydrostatic pressure comprises:
subjecting the at least one treating iron component to at least one predetermined hydrostatic pressure level; and
maintaining each said hydrostatic pressure level for a predetermined time interval.

13. The method according to claim 11 wherein detecting the test acoustic emission comprises detecting one or more test acoustic events and measuring one or more parameters of the test acoustic events.

14. The method according to claim 13 wherein the parameters are selected from number of acoustic events, count and amplitude.

15. The method of claim 13, wherein a plurality of acoustic sensors are each attached to a different location in the immersion tank to define a three-dimensional sensor arrangement; and
wherein detecting the test acoustic emission further comprises:
recording a time of arrival of the one or more test acoustic events at each acoustic sensor; and
determining a location of origin of each test acoustic event from the time of arrival of each test acoustic event at each acoustic sensor and the three-dimensional sensor arrangement.
